(19) United States
(12) Patent Application Publication
(10) Pub. No.: US 2022/0259744 A1
(43) Pub. Date: Aug. 18, 2022

(54) COMPOSITION FOR PRODUCING CORROSION RESISTANT ALLOY CLAD METAL PIPES

(71) Applicant: ADVANCED MATERIAL SOLUTIONS B.V., The Hague (NL)

(72) Inventors: Hu Chun YI, Golden, Denver, CO (US); Jeremy Joseph ITEN, Littleton, Denver, CO (US)

(73) Assignee: ADVANCED MATERIAL SOLUTIONS B.V., The Hague (NL)

(21) Appl. No.: 17/612,475

(22) PCT Filed: May 28, 2020
(86) PCT No.: PCT/NL2020/050345

§ 371 Date: Nov. 18, 2021

(30) Foreign Application Priority Data
May 28, 2019 (NL) 2023226

(51) Int. Cl. C23C 26/00

(52) U.S. Cl. CPC C23C 26/00

(57) ABSTRACT

A composition of an exothermic mixture suitable for a cladding process, comprising at least one transition metal oxide and at least one fuel, wherein the fuel is at least a binary mixture selected from the group of aluminium, calcium, magnesium or silicon. The invention is furthermore directed to a process for producing corrosion resistant alloy clad metal pipes by loading and distributing the exothermic mixture to one or more pipes in a clad assembly, followed by igniting the exothermic mixture and applying a post cladding pipe procedure.

### FIELD OF THE INVENTION

The present invention relates to compositions of exothermic mixtures suitable for a cladding process. It furthermore relates to a process of producing corrosion resistant alloy clad metal, preferably steel pipes. Moreover, it relates to the process of manufacturing a clad pipe comprising a corrosion resistant interior layer which is metallurgically bonded to a structure-supporting exterior carbon steel, low alloy steel, or chrome-molybdenum steel pipe. Such clad pipes are widely used in the oil and gas and chemical industries to transport corrosive fluids such as crude oil or chemical acids.

### BACKGROUND OF THE INVENTION

In the oil and gas field, recovery or transportation of crude oil often requires the use of pipes made of corrosion resistant alloys, further referred to herein as CRAs. However, pipes made of solid CRAs are not only expensive; they may also not meet the mechanical properties such as e.g., strength and toughness, required in some applications. Thus, the standard practice in the industry is to use more economically viable CRA clad pipes, i.e. pipes which contain a CRA layer at the interior and typically a metal, preferably a carbon steel backing exterior, with the CRA layer providing corrosion resistance and the steel backing providing structural support. These are presently mainly prepared from composite materials comprising flat, CRA-clad steel plates wherein a carbon steel, low alloy steel or the like plate is clad with a stainless steel, titanium, or another corrosion resistant material layer, depending on the application.

In particular the Oil and Gas Industry uses the guidelines issued by the National Association of Corrosion Engineers, e.g., NACE MR-01-75, to select CRAs, depending on the conditions and properties of crude oil, namely, temperature, pressure, velocity, and the mix of corrodents present in the gas stream such as hydrogen sulfide (H₂S), carbon dioxide (CO₂) and chloride ions (Cl⁻). Typical CRAs include stainless steels, copper-nickel alloys, and nickel-based super alloys.

The majority of clad pipes used in the market are manufactured from clad plate, which is usually fabricated by hot-roll-bonding, explosive bonding or other techniques, and then bent into the pipe shape, welded at the seam, and post-weld heat treated. Although this method of manufacture is suitable for high volume production, it is relatively slow and may have difficulty manufacturing large diameter and thick-walled pipes. Also, the presence of the weld may cause major issues in the strength and corrosion resistance of such pipes.

Moreover, it also requires a relatively large capital investment. Other methods and processes include weld overlay deposition and co-extrusion techniques. A disadvantage of these processes is that they are time and labor intensive and costly.

Combustion Synthesis (CS) or Self-Propagating High Temperature Synthesis (SHS) is a technique for rapid synthesis of advanced metals, alloys, ceramics, glasses, and metal-ceramic composite materials.

U.S. Pat. No. 4,363,832 by Odawara describes a combination of centrifugal casting and Combustion Synthesis technology used to produce ceramic (alumina, Al₂O₃) lined steel pipes, according to the following thermite-type chemical reaction:

$$3 {Fe}_{3} {O}_{4} + 8 Al {\to }^{ignition} 4 {Al}_{2} {O}_{3} + 9 Fe + Q \qquad ( 1 )$$

This aluminothermic reduction reaction releases heat (Q) such that if the iron oxide and aluminum (Al, as fuel) is ignited by an external heat source, a self-sustaining exothermic chemical reaction will be initiated forming molten alumina (Al₂O₃) slag and molten metallic iron (Fe). Due to the large difference in density between the slag and molten Fe, with sufficient centrifugal forces and duration of the molten states, the slag is separated out from the Fe, with the alumina forming a ceramic lining layer on the inner diameter of the pipe. A disadvantage of the method as described in U.S. Pat. No. 4,363,832 is that the ceramic lining layer is not metallurgically bonded to the steel pipe, and has typically a density of between 70 to 95%, with a significant number of pores, cracks, and other defects. A further disadvantage is that the ceramic layer lacks ductility and has a low fracture toughness, hence it can be easily damaged or broken off especially by mechanical forces (bending, impact, etc.) during the pipe laying operation. Such ceramic-lined steel pipes would not be suitable for most oil and gas applications.

U.S. Pat. No. 4,150,182 by Pignocco describes a method of producing a refractory lining in a cylinder or a tube by initiating as exothermic reduction reaction the aluminothermic reduction reaction, within the cylinder and causing the reaction products to coat the interior of the tube substantially uniformly. The resulting product is a ceramic or refractory-lined cylinder. Such ceramic-lined steel pipes would not be suitable for most oil and gas applications.

Accordingly, there is a demand for alternative techniques to manufacture high quality clad pipes that can withstand mechanical forces. There is furthermore a demand for corrosion resistant pipes that are suitable for many applications in the oil and gas industry. There is furthermore a need to produce these pipes via a more economically attractive process.

### SUMMARY OF THE INVENTION

It is an object of the present invention to provide novel exothermic particulate mixtures for producing clad pipes. It is another object of the invention to provide a technique to manufacture clad steel pipes with a corrosion resistant alloy metallurgically bonded to the interior surface of the backing steel pipe. It is a further object to use Combustion Synthesis (CS) or Self-Propagating High Temperature Synthesis (SHS), advantageously combined with centrifugal spinning as technique for producing clad pipes with a corrosion resistant metallic layer onto the pipes. It is a further object of the present invention to provide clad steel pipes that can be used in the oil and gas and other industrial applications.

Accordingly, the present invention relates to a composition of an exothermic particulate mixture capable of an exothermic combustion synthesis reaction and suitable for a cladding process, comprising at least one transition metal oxide and at least one fuel composition, wherein the fuel composition comprises at least a binary mixture selected from the group of aluminum, calcium, magnesium and/or silicon. The exothermic particulate mixture compromising at least a transition metal oxide and fuels generate, after the combustion synthesis reaction, the CRA of design and a slag having a composition consisting of two or more oxides exhibiting both a lower density and lower melting temperature than that of aluminum oxide, which enhances easy removal to have obtain a metal coating inside a pipe or cylinder for example.

The present invention also relates to a process for producing corrosion resistant alloy clad metal pipes by:
(a) loading the exothermic mixture according to the invention into one or more pipes in a clad assembly;
(b) igniting the exothermic mixture; and
(c) applying a post cladding pipe procedure.

### DETAILED DESCRIPTION OF THE INVENTION

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

The term “clad material” as used herein, includes materials that have been used widely in various applications. A clad material is generally a combination of two different types of metals or alloys that are adhered to one another such that the desirable characteristics of each of the metals can be utilized.

The term “metal pipes” as used herein, includes pipes made of steel, nickel and any other suitable tubular shaped structures. The term “steel pipes” as used herein, includes pipes made of carbon steel, low alloy steel, or chrome-molybdenum steel or combinations thereof. The size of the pipe varies depending on the application of the pipe in industry. The pipes might have a diameter of between 10 cm and 200 cm and 50 cm up to 30 m long.

The term “exothermic mixtures” herein refers to a particulate composition capable of reacting exothermically upon ignition, and forming a corrosion resistant alloy in a thermite-type reaction. The exothermic mixtures comprise an oxidizable inorganic fuel, such as an oxidizable metal or another element, in a fuel-effective amount, and an oxidizing agent, in an oxidizer-effective amount.

The term “alloy” as used herein, includes a metal made by combining two or more metallic elements.

The pipe cladding process according to the invention preferably begins with the provision, and preparation of a backing metal, preferably steel pipe, and of the exothermic mixture to be employed in the cladding process.

The exothermic mixtures generate, once ignited, high heat and rapidly produce the targeted product materials. The exothermic mixture comprises at least one transition metal oxide and at least one fuel. Since only a small energy input is required to ignite the precursors exothermic mixture, the technique requires very little external energy and the conversion to CRA might be performed in-situ such as inside the backing pipe. Therefore, the technology of the invention is efficient and economical. High product purity of the formed CRA is another demonstrated advantage because the extremely high reaction temperatures vaporize any volatile impurities.

The exothermic mixture of the invention contains preferably other metals or alloys or their oxides, other oxides or fluorides. The overall exothermic reactions can be expressed by:

$${\sum }_{i} {a}_{i} {MO}_{x i} + {\sum }_{j} {b}_{j} {f}_{j} + {\sum }_{k} {c}_{k} {M}_{k} + {\sum }_{l} {d}_{l} {S}_{l} {\to }^{ignition} Slag + CRA + Q \qquad ( 2 )$$

where MOₓᵢ represents the transition metal oxide, fⱼ the fuel, Mk the alloying metals, Si the other substances such as fluorides or other oxides, and a, b, c and d are numerical numbers. Reaction (2) indicates that if the reactant mixture of transition metal oxides, fuel components, alloying metals and other substances is brought to the ignition temperature (T_{ig}), an exothermic chemical reaction (Combustion Synthesis) is initiated in a self-propagating nature forming the products of slag (mixture of oxides, fluorides and/or other oxides) and corrosion resistance alloy (CRA), releasing a large amount of energy Q, and heating the product to a high temperature (termed as the Combustion Temperature, Tc).

The transition metal oxides are preferably selected from the group consisting of copper oxides, iron oxides, nickel oxide, niobium oxides, chromium oxides, cobalt oxides, manganese oxides, molybdenum oxides, tungsten oxides, and mixtures thereof. More preferably, the transition metal oxides are selected from the group consisting of CuO, Cu₂O, Fe₂O₃, Fe₃O₄, NiO, Nb₂O₅, Cr₂O₃, Co₃O₄, MnO₂, Mo₃O₄, WO₃, and mixtures thereof, depending on the desired CRA composition.

The fuel components are selected from the group consisting of aluminium, calcium, magnesium, silicon and mixtures thereof, preferably calcium and mixture thereof. The fuel components may be in the form of elements, or alternatively in the form of binary, ternary, quaternary, or higher alloys. The exothermic mixture will preferably also include metals and/or alloys to provide the desired composition of the CRA, in combination with the metal produced by reduction of the transition metal oxide (or oxides) by the fuel components. Carbon, boron or a source of carbon and boron may be included if carbon or boron CRA compositions are desired. Preferably, other slag modifying substances, such as alkaline or alkaline earth metal oxides or fluorides may be included in order to vary the properties of the slag. Silicon oxide and boron oxide may be included in the exothermic mixture as slag modifying constituents or as oxidizers and sources of silicon and boron for the CRA.

As described earlier, aluminum has been used as fuel shown in Reaction (1), and by changing the oxide metals and metal additions, aluminum can be used as one of the fuel components in forming the CRA. The ignition temperature of the mixture is around the melting point of aluminum, which is 660° C. Once ignited, the exothermic mixture undergoes an exothermic chemical reaction forming a slag of aluminum oxide (Al₂O₃) and molten CRA and might reach a maximum temperature of the chemical reaction (Tc) of up to 3000° C. The melting point and specific density of Al₂O₃ are 2054° C. and 3.95 g/cm³ respectively. A disadvantage of the process with aluminum as fuel according to the prior art is that the high melting temperature of the aluminum oxide slag can result in early solidification of the slag which limits the ability to protect the molten CRA underneath from oxidation, may result in inadequate slag separation from the molten CRA and may cause a rough surface on the CRA underneath. As typical CRAs have a melting point around 1500° C. or below and a density above 7.7 g/cm³, the Al₂O₃-based slag is separated out at this Tc from the molten CRA under centrifugal force with the CRA bonding to the steel substrate and the slag rising towards the surface due to buoyancy force. Upon subsequent cooling, the aluminum oxide slag will solidify much faster than the CRA. Since the slag is typically porous, it cannot protect the molten CRA underneath from oxidation, which typically results in a poorer quality of the CRA. Moreover, the slag (Al₂O₃) has a very high hardness value and is very difficult and expensive to remove after the clad operation.

Magnesium may also be used as one of the components in the exothermic mixture to form the CRA. The ignition temperature of the mixture is around the melting point of magnesium (650° C.). Once ignited, the exothermic mixture undergoes exothermic chemical reactions forming a slag of magnesium oxide (MgO) and molten CRA and reaches a Tc up to 3000° C. The melting point and specific density of the MgO are 2852° C. and 3.58 g/cm³ respectively. Since the typical CRAs have a melting point around 1500° C. or below and a density above 7.7 g/cm³, the slag is readily separated out at this Tc from the molten CRA under the centrifugal force with the CRA bonding to the steel substrate while the slag following to the top. However, upon subsequent cooling, the slag will solidify much faster than the CRA due to the higher melting temperature than that of the CRA. Too early solidification of the slag would limit the ability to protect the molten CRA underneath from oxidation and may also lead to poorer CRA quality due to reduced separation characteristics of the slag from molten CRA. Moreover, this type of exothermic reaction is very violent due to the relatively low evaporation temperature of magnesium.

Calcium may also be used as one of the components in the exothermic mixture to form the CRA. The ignition temperature of the exothermic mixture is around 790° C. with the melting point of calcium being 842° C. Once ignited, the exothermic mixture undergoes exothermic chemical reactions forming a slag of calcium oxide (CaO) and molten CRA and reaches a Tc up to 3000° C. The melting point and specific density of the CaO are 2615° C. and 3.34 g/cm³ respectively. Since the typical CRAs have a melting point around 1500° C. or below and a density above 7.7 g/cm³, the slag is readily separated out at this Tc from the molten CRA under centrifugal force with the CRA bonding to the steel substrate while the slag following to the top. However, upon subsequent cooling, the slag will solidify much faster than the CRA due to the higher melting temperature than that of the CRA. Too early solidification of the slag would limit the ability to protect the molten CRA underneath from oxidation and may also lead to poorer CRA quality due to reduced separation characteristics of the slag from molten CRA. Moreover, elemental calcium is highly hygroscopic and is also difficult to be made into fine powders.

Silicon may also be used as one of the components in the exothermic mixture to form the CRA. The ignition temperature of the mixture is around the melting point of silicon (1414° C.). Once ignited, the exothermic mixture undergoes exothermic chemical reactions forming a slag of silicon oxide (SiO₂) and molten CRA and reaches a Tc up to 2400° C. The melting point and specific density of the SiO₂ are 1713° C. and 2.65 g/cm³ respectively. Since the typical CRAs have a melting point around 1500° C. or below and a density above 7.7 g/cm³, the slag is readily separated out at this Tc from the molten CRA under centrifugal force with the CRA bonding to the steel substrate while the slag following to the top. However, upon subsequent cooling, the slag will solidify faster than the CRA due to the higher melting temperature than that of the CRA. Too early solidification of the slag would limit the ability to protect the molten CRA underneath from oxidation and may also lead to poorer CRA quality due to reduced separation characteristics of the slag from molten CRA. Moreover, this type of exothermic reaction has a relatively lower exothermicity thus making the clad process less efficient.

According to the invention, exothermic fuel mixtures are being used, being binary fuel components selected from Al, Ca, Mg and Si and that upon ignition and reaction form a slag with binary oxides of Al₂O₃, CaO, MgO and SiO₂. Preferably, the overall fuel is binary, ternary, or quaternary mixture selected from the group of aluminium, calcium, magnesium or silicon, more preferably a binary, ternary, or quaternary fuel components comprising at least calcium and one out of the group of aluminium, magnesium or silicon, even more preferably a binary mixture of calcium and one out of the group of aluminium, magnesium or silicon. The advantage of using a binary, ternary, or quaternary fuel component mixture is that the ignition temperature can be designed, the exothermicity of the reactions that take place can be tailored, and the melting temperature and composition of the slag can be tailored including to improve ease of removal. Additionally, alloyed fuel mixtures can be designed with better environmental stability than single element fuels such as Ca or Mg. Furthermore, the raw materials are readily available and economical to be fabricated into fine particulate form. The exothermic particulate mixture compromising at least a transition metal oxide and fuels generate, after the combustion synthesis reaction, the CRA of design and a slag having a composition consisting of two or more oxides exhibiting both a lower density and lower melting temperature than that of aluminum oxide, which enhances easy removal to have obtain a metal coating inside a pipe or cylinder for example.

A preferred exothermic mixture according to the invention may use a binary mixture of Al and Si as the fuel components, either in the form of elemental powders or alloys. The preferred weight ratio of Al/Si is the range of from 0.1 up to 1.2. An exothermic mixture comprising the above fuel ratio exhibit an ignition temperature between the melting points of Al and Si and upon ignition and reaction form a slag with a binary Al₂O₃—SiO₂ oxide and CRA. Such a slag exhibits a solidus temperature of 1587° C. and a density around 2.4 g/cm³, both properties are lower than those of the individual oxides, hence would have better slag and CRA separation as well as molten CRA protection characteristics than the respective individual oxides.

An even more preferred exothermic mixture according to the invention may use a binary mixture of Ca and Si as the fuel components, either in the form of elemental powders or alloys. The preferred weight ratio of Ca/Si is the range of from 0.7 up to 2.0. Exothermic mixture with this fuel ratio exhibits an ignition temperature between the melting points of Ca and Si and upon ignition and reaction form a slag with a binary CaO—SiO₂ oxide slag and CRA. Such a slag exhibits a melting point around 1450-1550° C. and a density around 2.5-2.6 g/cm³, both properties are lower than those of the individual oxides, hence would have better slag and CRA separation as well as molten CRA protection characteristics than the respective individual oxides.

An even more preferred exothermic mixture according to the invention may use a binary mixture of Al and Ca as the fuel components, either in the form of elemental powders or alloys. The preferred weight ratio of Al/Ca is the range of from 0.33 up to 1.5. Exothermic mixture with this fuel ratio exhibits an ignition temperature below 600° C. and upon ignition and reaction form a binary CaO—Al₂O₃ oxide slag and CRA. Such a slag exhibits a melting point around 1390-1450° C. and a density around 2.6-2.8 g/cm³, both properties are lower than those of the individual oxides, hence would have better slag and CRA separation as well as molten CRA protection characteristics than the respective individual oxides.

Still even more preferred exothermic mixtures of the current invention may also use ternary, i.e. the combination of Al, Ca and Si, or even quaternary fuel components, either in the form of elemental powders or alloys.

Preferably, the exothermic mixture comprises at least one transition metal oxide and at least one fuel component in a molar ratio appropriate to form the product phases with minimal excess fuel or oxide. For example, for equation 1 above, a ratio of 3:8 is preferred. In some cases, it is preferred to have to have excess fuel or excess of oxide.

Advantageously, one or more other oxides or fluorides can furthermore be added to the mixture. One advantage of adding additional oxides or fluorides is that the viscosity or density of the slag might be reduced, promoting the separation of the molten CRA from the slag. Additionally, additional oxides or fluorides can make the slag easier to remove. Preferably, the exothermic mixture furthermore comprises an oxide or fluoride of the group of alkaline earth metals, more preferably an oxide or fluoride of barium, silicon, calcium or magnesium or mixtures thereof. Advantageously, the other oxides and/or fluorides do not exceed 10 weight % in the mixture.

Advantageously, further alloying metals and/or alloys next to the transition metal oxides can be added to the exothermic mixture, amongst them are one or more metals selected from the group of copper, iron, tin, nickel, chromium, cobalt, vanadium, manganese, molybdenum, silicon and the alloys thereof.

Advantageously, the final CRA formed by the exothermic chemical reaction may be any suitable steel composition, such as 316L or any other stainless steels. In another preferred embodiment, the CRA formed by the exothermic chemical reaction advantageously may also be that of any copper alloy compositions such as cupronickel alloys, comprising preferably in the range of from 10 up to 30 weight % of Ni. The advantage of the formed cupronickel alloys is that they exhibit excellent resistance to salt water, such as water comprising a high concentration of halogen ions. In another preferred embodiment, the final CRA formed by the exothermic chemical reaction may be that of any nickel super alloys such as Inconel 625 or Hastelloy C-2000. The advantage of the formed nickel super alloys is that they exhibit excellent resistance to acid attacks. Preferably, the final corrosion resistant alloy formed by the exothermic chemical reaction the comprises stainless steels, copper-nickel alloys, and nickel super alloys.

Advantageously, the exothermic mixture of the current invention is prepared from particulate materials, i.e. powdery materials, with a particle size preferably in the range of from 20 micron (μm, equivalent to 650 mesh), more preferably 37 micron (μm, equivalent to 400 mesh), even more preferably 44 micron (μm, equivalent to 325 mesh) up to 707 (μm, equivalent to 25 mesh), more preferably up to 500 micron (μm, equivalent to, 35 mesh).

Powders with smaller or larger particle sizes may also be used, but smaller particles may exhibit reduced flow, reduced bulk density, increased cost, increased likelihood of becoming airborne, and increased susceptibility to moisture and oxidation, whereas larger particles may result in a slower chemical reaction rate, and therefore may reduce the homogeneity of the formed CRA layer.

The exothermic mixture is advantageously prepared by thorough dry mixing of the constituent components, for instance by tumbling for a sufficiently long period, preferably for at least two hours.

The present invention also relates to a process for producing corrosion resistant alloy clad metal, preferably steel pipes by:
(a) loading and distributing the exothermic mixture previously described to one or more pipes in a clad assembly;
(b) igniting the exothermic mixture; and
(c) applying a post cladding pipe procedure.

Optionally, the metal pipe surface to be clad is cleaned thoroughly, more preferably either by sand blasting, and/or by using a chemical wash followed by drying. Even more preferably, the chemical wash is done using a weak acid, even more preferably acetic acid. The concentration of the acetic acid is preferably between 1 and 10 vol %, more preferably between 4 and 6 vol % in water or aqueous solution. The advantage of cleaning of the pipe surface is that it makes bonding of the corrosion resistant alloy or metal with the pipe easier since it requires relatively lower energy from the exothermic mixture and forms a more uniform and purer CRA layer, e.g. containing less inclusions. This process is not critical since the exothermic mixture is capable of reducing the oxidation layer and acting to be self-fluxing during the reaction, i.e., the rust or contaminants left could be dissolved into the slag that was formed in the reaction.

The exothermic mixture is preferably loaded onto the steel pipe at a rotational velocity generating a centrifugal force of at most 10 times the gravitational force (g) and wherein the exothermic mixture is ignited using an ignition system at a rotational velocity generating a centrifugal force of at least 50 times the gravitational force (g). More preferably, loading the exothermic mixture to the steel pipes is done at a rotational velocity generating a centrifugal force of at least 1 g, more preferably at least 2 g and at most 10 g, more preferably at most 8 g, and wherein igniting the exothermic mixture is done using an ignition system at a rotational velocity generating a centrifugal force of at least 100 g, preferably at least 150 g. The advantage of having the exothermic mixture of the invention in combination with ignition at these centrifugal forces is that for the duration of the molten states, the slag is separated out from the molten metal forming a slag layer on the inner diameter of the clad layer, which might be easily removed to leave a smooth metallic clad layer on the inside of the backing pipe.

Alternatively, the exothermic mixture is loaded onto the steel pipe at rest, and the exothermic mixture is ignited using an ignition system at a rotation velocity generating a centrifugal force of at least 50 times the gravitational force (g).

The process of the invention also includes powder mixture loading and distribution techniques, which load the powder mixture to the inner surface of the pipe. Preferably, the powder mixture is loaded by a method such as a powder spray method, screw feed method, or fluidized powder method during rotation so that the exothermic mixture is well distributed around the pipe inner diameter, or the powder is loaded with the pipe at rest using a tube method, expandable cylinder method, or loaded with the pipe at rest or at a low centrifugal force and then distributed by blade powder spreading (BPS) method or revolutions per minute (RPM) variation method. In the blade powder spreading (BPS) method, it is preferred to load and spread the powder mixture around the inner wall of the backing steel pipe by moving a spreading blade, a rod, a roller, or similar spreading device inside the pipe lumen towards the pipe inner diameter into the power mixture while the pipe is rotated at a rotational velocity expressed in revolutions per minute sufficient to generate a centrifugal force greater than 1 g (g-force, with 1G=9.8 m/s²) and preferably of from 2 up to 10 times the gravitational force g (of from 2 g up to 10 g). Thus, preferably spreading the exothermic mixture to the steel pipes is done at a rotational velocity generating a centrifugal force of at least 1 g, more preferably at least 2 g and at most 10 g, more preferably at most 8 g. In the tube method, it is preferred to place a tube with an outside diameter (OD) smaller than the inner diameter of the backing pipe at the center of the backing steel pipe and the gap between the tube and inner diameter of the backing steel pipe is filled with the exothermic powder mixture of the current invention. The OD of the tube is determined from the physical properties of the mixture, packing density, and the targeted thickness of the CRA clad layer. The tube used is preferably comprised of a material that will burn away during the mixture reaction (e.g. a paper or cardboard tube) or be incorporated into the slag (e.g. an oxide or aluminum tube), more preferably comprised of a material that will burn away during the mixture reaction (e.g. a paper tube). In the expandable cylinder method, the pipe is oriented vertically and an expandable cylinder, such as an inflatable hydraulic or pneumatic diaphragm, with a starting diameter less than the inner diameter of the backing pipe is centered in the lumen along the length of the pipe. The exothermic mixture is then loaded in the space between the expandable cylinder and the backing pipe and the expandable cylinder is then expanded to compact the loaded powder against the backing pipe inner diameter. The cylinder is then returned to the original smaller diameter and removed from the backing pipe lumen and the backing pipe is placed into the centrifugal assembly. In the RPM variation method, the powder mixture is loaded into the pipe lumen with the pipe at rest and the pipe is then rotated at a rotation speed that generates a gravitational force less than 1 g to allow the powder mixture to tumble initially, then the revolutions per minute are slowly increased to higher g levels until it reached at most about 10 g. The powder closest to the center of the pipe will experience less g force at a given RPM than the powder further outward and closer to the pipe inner diameter. At a rotational velocity where the inner diameter experiences less than 1 g force, the majority of the powder will tumble as the pipe rotates while when the g force matches gravity at the inner diameter, the powder further towards the pipe center will experience less than 1 g force and continue to fall as the pipe rotates. When the rotational velocity is increased such that the g force at the pipe inner diameter is slightly higher than 1 g, then a certain thickness of powder will be held in place by the centrifugal forces and powder further inward will continue to tumble. With this method of slowly increasing the rotational velocity, the powder can be distributed uniformly around the inner circumference of the backing pipe until all powder is held in place by the centrifugal forces. Preferably, the rotational velocity can be controlled by changing the speed of the motor such as with use of a variable frequency drive to change the speed of an electric motor, or through a continuously variable transmission or any other suitable method and more preferably the process can be automated. The powder spray method uses preferably a spray nozzle and the screw feed method preferably uses a screw feed from a hopper and both would allow for retracting the feed mechanisms to cover the length of the pipe while the powder is fed during rotation of the pipe at >1 g and preferably between 2 and 10 g. The fluidized powder method would preferably use a liquid powder suspension to allow the powder to spread uniformly during pipe rotation and then the liquid would be evaporated or boiled away. Preferably, step (a), loading and distributing the exothermic mixture to the steel pipes in a clad assembly at rest of an RPM generating a centrifugal force of at most 10 times the gravitational force is being performed using the RPM variation method, blade powder spreading method, expandable cylinder method, or paper tubing method.

Alternatively, it is preferred to load the powder mixture to the pipe in two steps. For example, in the first step, the exothermic powder mixture is loaded to the inside of the clad pipe by the BPS method. Afterwards, another powder, such as fluorspar (CaF₂ or other fluorides) or silica (SiO₂ or any other oxides), or mixtures thereof, is loaded into the pipe while the pipe is still in rotation at a g force greater than 1 g and preferably greater than 2 g. After the ignition of reaction, the powder (or mixture) loaded in the second step combines with the slag generated from the reaction of the exothermic mixture forming a new slag composition, thus improves the properties of the overall slag. The advantage of this methodology is that it can form a slag with the desired composition and properties without having to mix the fluoride or silica introduced in the second step into the exothermic mixture intimately since the fluoride or silica dilutes the exothermicity of the mixture (termed as a diluent) thus reducing the combustion temperature of the reaction.

An end cap having a centre opening is preferably welded to one or both ends of the backing pipe. The diameter of the opening is advantageously determined from the physical properties (e.g., mass, particle size and loose packing density) of the powder mixture and the dimensions of the backing pipe (e.g., inner diameter) and a powder spread blade (e.g., width). The wall thickness of the end cap is preferably the same as that of the wall thickness of the backing pipe or thicker, and the length of the end cap is advantageously the same or smaller than 1 inch or about 2.5 cm. The advantage of using end caps is that they extend the length of the backing pipe and hence would make sure the entire length of the backing pipe is cladded uniformly since the ends usually contain some kinds of defects due to less exothermic powder mixture. The end caps are advantageously cut off after clad operation.

Techniques to ignite the exothermic mixture include using an ignition system consisting of one or more reactive (green) pellets, ignition coils and electrical power supplies.

Green pellets are pellets that are pressed from compatible or similar exothermic mixtures, or the same exothermic mixture that is used in the process. They are then preferably placed in ignition coils that are placed inside the inner diameter of the pipe. The number and spacing of the ignition pellets is determined from the length of the pipe to be clad and the reaction rate of the mixture. Depending on the circumstance, ignition pellet placement may be at only one end of the pipe, at both ends of the pipe, or at regularly spaced intervals such as one or two meters apart. Each pellet is preferably placed inside an ignition coil made of electrically resistant wires such as Kanthal or tungsten wire or with a chemically reactive ignition fuse. Those pellets can be ignited by the same power supply by connecting all ignition coils to the same power supply and applying a sufficient electrical voltage and current or ignited by multiple power supplies at the same time. Similarly, the pellets could be ignited by one ignition fuse or multiple ignition fuses. Upon ignition of the pellets, the exothermic reactions generate a mixture of molten CRA and slag, which falls onto the powder mixture already loaded in the backing steel pipe, thus igniting the powder mixture. Preferably, green pellets are prepared by uniaxial pressing of the exothermic mixture of the process, followed by placing inside the pipes a resistant wire and a power supply. The pellets are preferably placed from each other at a distance that is calculated from the reaction rate of the powder mixture. More preferably, the pellets are placed at a distance of from 60 cm up to 300 cm, more preferably 80 cm up to 120 cm, even more preferably 95 cm up to 105 cm, most preferably at 100 cm from each other, if more green pellets are required. In many cases, only 1 or 2 green pellets are required to ignite the exothermic mixture.

The method of the invention also includes a process for cooling the clad pipe by using a cooling medium before step (c). Preferably, the cooling medium is water, more preferably a water spray. At a time after the completion of the exothermic reaction preferably a quench system is used to spray water onto the outer and/or inner walls of the newly cladded pipe. For this purpose, the clad assembly preferably comprises an array of water spraying nozzles. The water spraying nozzles cool down the clad pipe and may also assist in removing the slag by thermal shock. Alternatively, a water tank could also be placed underneath the clad assembly and the pipe is allowed to drop into the water tank at a pre-determined time after the clad operation thus cooling the entire pipe. Water cooling greatly assist the subsequent slag removal since it thermally shocks the slag.

The method of the invention furthermore finishes the process with a post cladding pipe procedure. This final step may include removing any remaining slag through mechanical methods. Preferably, the post cladding pipe procedure includes breaking off slag by mechanical means, more preferably by mechanical means assisted by the thermal shock water spraying and/or by surface machining. More preferably, a final step of the method may include smoothing out the clad surface if needed through mechanical methods.

Thus, the invention includes advanced exothermic powder mixtures that comprises transition metal oxides, fuel components, and/or alloying metals and/or alloys, and may contain other materials such as fluorides or oxides. Once ignited, the exothermic mixtures of the invention generate molten CRAs of design and a molten ceramic or glass by-product (here referred to as “slag”) that is much easier separated from the molten CRA under centrifugal force than the prior art invention represented by reaction (1), thus leading to higher quality (purer) CRA than the prior art invention. The molten CRA is bonded to the backing steel pipe metallurgically, while the slag flows to the inner most surfaces due to the large difference in specific gravity between the slag and CRA.

The following, non-limiting embodiments of the invention are further described hereinafter with reference to the accompanying figures, wherein like letters and numerals refer to like parts, wherein the figures are approximately to scale, and wherein:

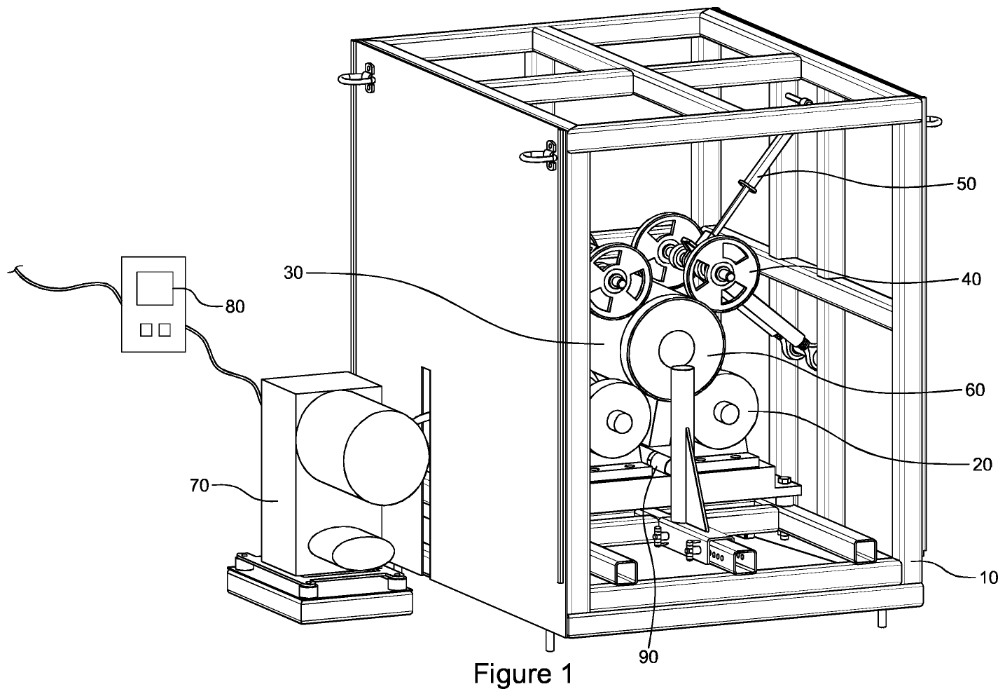

FIG. 1 illustrates an example of a cladding operation that is carried out in a centrifugal assembly.

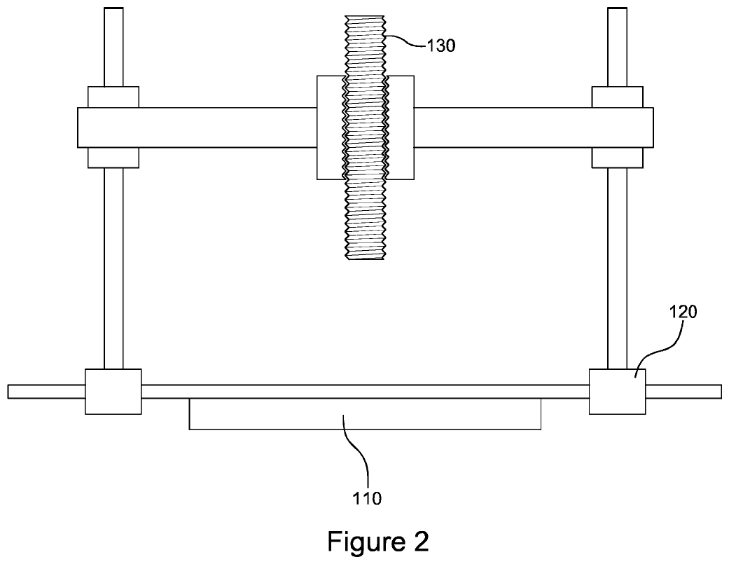

FIG. 2 illustrates an example of an assembly that is used to spread and compact the powder mixture.

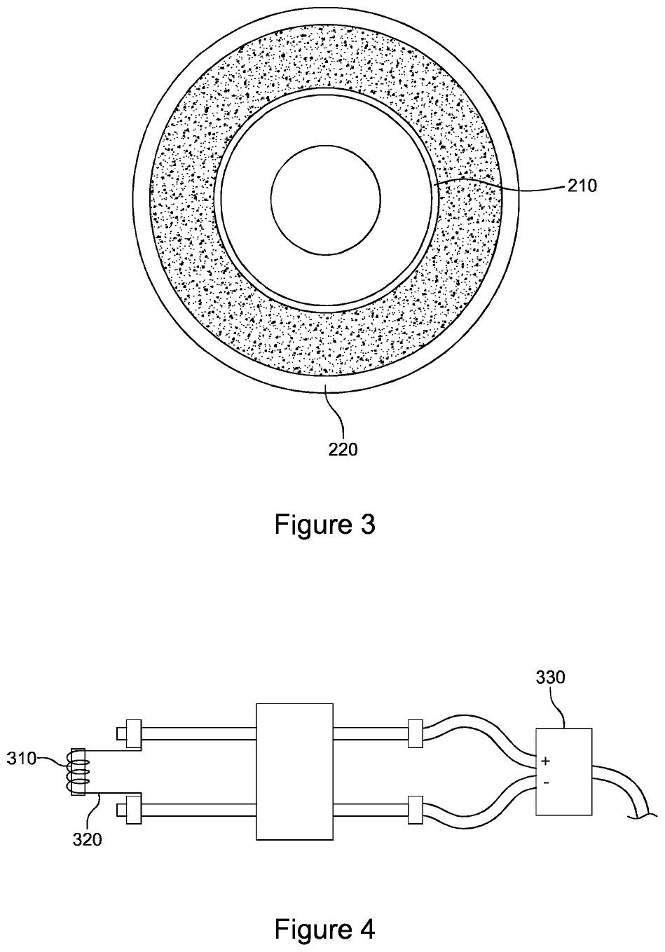

FIG. 3 illustrates an example of a paper tube that is placed inside at the centre of the pipe.

FIG. 4 illustrates an example of an ignition set up.

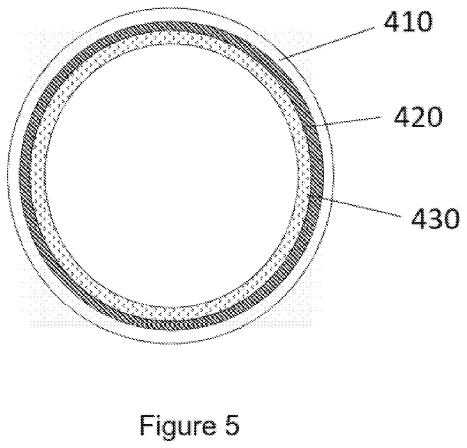

FIG. 5 illustrates the cross section of the clad pipe.

FIG. 1 illustrates an example of the cladding operation that is carried out in a centrifugal assembly. The centrifugal assembly is comprised of modules with the number of modules scalable with pipe length. In this non-limiting embodiment each module includes a structural platform (10) which hosts four steel wheels (20). The backing pipe (30) is placed onto the four wheels (20), and the pipe (30) is confined on top by four steel wheels (40) which are mounted to the structural frame using two shocks comprised of spring and dashpot mechanisms (50). Each spring shock can apply force to the clad pipe independently, thus enabling low resistance confinement of rotating eccentric pipes. Other wheel configurations for the module could also be used such as four lower wheels and two upper wheels or a minimal configuration of three wheels such as two lower wheels and one upper wheel. On each end of the backing pipe (30), there is an end cap (60) with an opening in the middle for ignition and for outgassing. One of the wheels on the bottom of the structural platform is driven by a motor (70), which is controlled by a variable frequency drive (VFD) (80) to vary the RPM of the motor. Some modules may not include their own motor and the motor may be controlled by other methods such as gearing or fuel intake. Underneath the bottom four wheels (20) there is a water quenching line (90) for cooling after the combustion synthesis reaction. The water quench line is fed by a pump and contains nozzles and a long enough line to have a spray reach that would extend out to the end of the pipe or the spray reach of the adjacent module to allow for uniform quench. Thus, it is preferred that the clad assembly includes mechanical support, an ignition system and a cooling system. It is furthermore preferred that the mechanical support includes a spring shock loaded mechanism to dynamically position and confine the pipe in rotation by wheels.

Prior the clad operation, the backing pipe is preferably prepared by removing rust and grease at the interior surface by for example sandblasting and/or by soaking the pipe in a 5% vinegar solution for at least 24 hours, following by water cleaning and drying.

The cladding operation starts with placing the backing pipe (30) between the four wheels (20) and (40), and the exothermic powder mixture is loaded into the pipe and distributed by one of the methods described above. In one method, the powder mixture is first loaded to the inside of the pipe, which is then rotated at a rotational velocity corresponding to the generation of a gravitational force of 2 g or higher. A device consisting of a blade (110) made of steel (or any other material), guide tracks (120) and adjusting screw (130) as illustrated in FIG. 2 is used to spread and compact the powder mixture. At first, the blade (110) is adjusted to be parallel to the inner surface longitudinally, and then lowered to the powder mixture while the pipe is in rotation at a rotational velocity corresponding to generate a gravitational force of at least 2 g. The blade will initially contact the highest areas of the powder and will spread these areas to lower areas. The blade is further lowered down to continue spreading until there is accumulation of powders near the blade edge. This operation ensures that all areas are sufficiently filled with powder and assists in compaction of the powder mixture. The blade is then slowly raised up until the accumulation of powder near blade edge disappears. This method is referred to as the Blade Powder Spreading (BPS) in this document. In some situations, the rotational velocity is intentionally increased to generate 10 g or higher in order to increase the packing density of the mixture. Other spreading devices such as a rod or roller may also be used to increase the amount of powder compaction.

In the another method, a combustible, e.g. paper, carton or wax tube (210) is placed inside at the centre of the backing pipe (220) as illustrated in FIG. 3. The outside diameter (OD) of the paper tube (210) is determined according to the mass and packing density of the powder mixture such that the amount of the powder mixture required to fill the space between the paper tube and backing pipe would form the required clad thickness. The powder mixture is then loaded in the gap between the outside diameter of the paper tube and inside diameter of the backing pipe. The powder mixture pre-loaded backing pipe is then placed onto the clad assembly between the four wheels (20) and (40) for subsequent cladding operation. This powder mixture loading is referred to as the paper tube (PT) method. Other methods such as the spray, screw feed, and fluidized powder methods as previously described may also be used.

In still another method, the powder mixture is loaded to the inside of the pipe. The pipe is then rotated at a rotational velocity in RPMs that generates a gravitational force less than 1 g to allow the powder mixture to tumble initially, then the rotational velocity is increased to higher g-levels until it reached about 4 g. The rotational velocity is increased slowly and continuously to allow the inner powder to continue to tumble until the powder is distributed with a uniform layer thickness around the inner circumference of the backing pipe. This method is referred to as the RPM variation method.

Once the powder mixture is loaded to the clad pipe, the rotation of the pipe is increased to a higher rotational velocity to generate a gravitational force of at least 50 g. The powder is then ignited by using a setup illustrated in FIG. 4. It consists of multiple green pellets (310) pressed from the same exothermic mixture as used for cladding or another compatible mixture, ignition coils (320) made of an electrically resistant wire suitable for Joule heating such a tungsten or Kanthal® (being a trademark of Sandvik) wire, and a power supply (330). Each coil holds one pellet, and all ignition coils may be connected electrically to the same power supply. Specific numbers of green pellet/ignition coil pairs are decided from the reaction rate of the exothermic mixture as well as the length of the pipe to be cladded. The essence of the ignition system in FIG. 4 is to attempt to clad the entire pipe at the “same time”. This is not only to save time, but the entire pipe would have a relatively uniform thermal profile. Alternative ignition methods may use a reactive fuse or ignite the mixture from only one or both ends.

The required rotational speed in RPM during the reaction is selected according to the combustion temperature of the reaction, compositions of the CRA and slag, and the diameter of the pipe. Typically, it is in the range of 500-2000 RPM, generating a gravitational force of 50-300 g, depending on the diameter of the pipes.

Shortly after the completion of the reaction, the pipe is cooled by water quenching, as shown in FIG. 1, by using a water quenching line (90). Cooling time is determined by consideration of energy generated by the exothermic reaction, pipe size, and water spraying rate.

The final clad pipe is illustrated in FIG. 5. It comprises a slag layer (430), the clad layer (420) comprised of CRA and the backing steel pipe (410).

The final step of the manufacture process preferably involves removing the slag thus exposing the CRA. In most cases, slag can be easily broken off by mechanical operation. The slag removal can also be assisted by thermal shock, i.e., spraying the slag with water while it is still hot thus cracking and weakening the slag.

Optionally, the clad pipe may be heat treated post-clad to obtain the desired microstructure and properties for the backing pipe and clad layer.

The following, non-limiting examples are provided to illustrate the invention. The clad pipe manufacture process is illustrated in the following using stainless steel as CRA examples.

For all examples except for example 8, a section of X60 carbon steel pipe having an outside diameter of 273.1 mm, a wall thickness of 11.1 mm and a length of 500 mm was cleaned by sand blasting and soaking in 5% white vinegar for 24 hours.

After loading the different exothermic mixtures, the ignition set up shown in FIG. 4 was used to ignite the mixture.

For all examples, the pipe was cooled shortly after the completion of the reaction, by spraying water from both inside and outside. Water spraying from inside the pipe leads to the weakening of the slag by thermal shocking, thus the slag could be readily removed from a subsequent mechanical operation.

### Example 1

An exothermic mixture containing iron oxide (Fe₂O₃), calcium (Ca) and aluminum (Al), and alloying metals of chromium (Cr), nickel (Ni), iron (Fe), molybdenum (Mo), silicon (Si), and manganese (Mn) was loaded to the inside of the pipe by the BPS method while the pipe was in rotation at approximately 250 RPM (˜8 g). Afterward, the RPM was raised to 1150 RPM (˜185 g) and the mixture was ignited. Shortly after the completion of the reaction, the pipe was cooled by spraying water.

Upon the ignition and reaction, the mixture formed molten CRA of stainless steel 316L composition and a molten slag of oxides (CaO and Al₂O₃). Owing to the large difference in specific gravities between the CRA and the slag, the CRA was deposited to the inner wall of the X60 backing pipe with the slag on top. Shortly after the completion of the reaction, the pipe was cooled by spraying water from both inside and outside and slag was removed using a separate mechanical operation. Examination of the cross sections of the cladded pipe showed that a strong metallurgical bond had been formed between the cladded layer and the X60 steel backing.

### Example 2

An exothermic mixture containing iron oxide (Fe₂O₃), chromium oxide (Cr₂O₃), calcium (Ca) and aluminum (Al), and alloying metals of chromium (Cr), nickel (Ni), iron (Fe), molybdenum (Mo), silicon (Si), and manganese (Mn) was loaded to the inside of the pipe by the paper tube (PT) method. Afterward, the RPM was raised to 1150 RPM (˜185 g) and the mixture was ignited. Shortly after the completion of the reaction, the pipe was cooled by spraying water.

Upon the ignition and reaction, the mixture formed molten CRA of stainless steel 316L composition and molten slag of oxides (CaO and Al₂O₃). Owing to the large difference in specific gravities between the CRA and the slag, the CRA was deposited to the inner wall of the X60 backing pipe with the slag on top. Shortly after the completion of the reaction, the pipe was cooled by spraying water from both inside and outside and slag was removed using a separate mechanical operation. Examination of the cross sections of the cladded pipe showed a strong metallurgical bond had been formed between the cladded layer and the X60 steel backing.

### Example 3

An exothermic mixture containing iron oxide (Fe₂O₃), calcium (Ca) and aluminum (Al), and alloying metals of chromium (Cr), nickel (Ni), iron (Fe), molybdenum (Mo), silicon (Si), and manganese (Mn) was loaded to the inside of the pipe using the RPM variation method. The powders were tumbled using an RPM that generates a gravitational force of about 0.5 g for 30 seconds. The RPM is then gradually increased to generate a gravitational force of 4 g with about 5 minutes taken to transition from 0.5 g to 4 g. Afterward, the RPM was raised to 1150 RPM (˜185 g) and the mixture was ignited. Shortly after the completion of the reaction, the pipe was cooled by spraying water.

Upon the ignition and reaction, the exothermic mixture forms molten CRA of stainless steel 316L composition and molten slag of oxides (CaO and Al₂O₃). Owing to the large difference in specific gravities between the CRA and the slag, the CRA was deposited to the inner wall of the X60 backing pipe with the slag on top. Shortly after the completion of the reaction, the pipe was cooled by spraying water from both inside and outside and slag was removed using a separate mechanical operation. Examination of the cross sections of the cladded pipe showed a strong metallurgical bond has been formed between the cladded layer and the X60 steel backing.

### Example 4

An exothermic mixture containing iron oxide (Fe₂O₃), calcium (Ca) and aluminum (Al), fluorspar (CaF₂) and alloying metals of chromium (Cr), nickel (Ni), iron (Fe), molybdenum (Mo), silicon (Si), and manganese (Mn) was loaded into the inside of the pipe by the BPS method while the pipe was in rotation at approximately 250 RPM (˜8 g). Afterward, the pipe was rotated at 1150 RPM (˜185 g) and the mixture was ignited. Shortly after the completion of the reaction, the pipe was cooled by spraying water.

Upon the ignition and reaction, the mixture forms molten CRA of stainless steel 316L composition and a molten slag made of oxides (CaO and Al₂O₃) and fluoride (CaF₂). Owing to the large difference in specific gravities between the CRA and the slag, the CRA was deposited to the inner wall of the X60 backing pipe with the slag on top. Shortly after the completion of the reaction, the pipe was cooled by spraying water from both inside and outside and slag was removed using a separate mechanical operation. Examination of the cross sections of the cladded pipe showed a strong metallurgical bond has been formed between the cladded layer and the X60 steel backing.

### Example 5

An exothermic mixture containing iron oxide (Fe₂O₃), calcium (Ca), silicon (Si) and aluminum (Al) and alloying metals of chromium (Cr), iron (Fe), nickel (Ni), molybdenum (Mo), and manganese (Mn) was loaded to the inside of the pipe by the BPS method while the pipe was in rotation at approximately 250 RPM (˜8 g). Afterward, the RPM was raised to 1150 RPM (˜185 g) and the mixture was ignited. Shortly after the completion of the reaction, the pipe was cooled by spraying water.

Upon the ignition and reaction, the mixture forms molten CRA of stainless steel 316L composition and a molten slag of oxides (CaO, SiO₂ and Al₂O₃). Owing to the large difference in specific gravities between the CRA and the slag, the CRA was deposited to the inner wall of the X60 backing pipe with the slag on top. Shortly after the completion of the reaction, the pipe was cooled by spraying water from both inside and outside and slag was removed using a separate mechanical operation. Examination of the cross sections of the cladded pipe showed a strong metallurgical bond has been formed between the cladded layer and the X60 steel backing.

### Example 6

An exothermic mixture containing iron oxide (Fe₂O₃), nickel oxide (NiO), chromium oxide (Cr₂O₃), calcium (Ca), aluminium (Al), and silicon (Si) and alloying metals of iron (Fe), molybdenum (Mo), and manganese (Mn) was loaded to the inside of the pipe by the BPS method while the pipe was in rotation at approximately 250 RPM (˜8 g). Afterward, the RPM was raised to 1150 RPM (˜185 g) and the mixture was. Shortly after the completion of the reaction, the pipe was cooled by spraying water.

Upon the ignition and reaction, the mixture forms molten CRA of stainless steel 316L composition and a molten slag of oxides (CaO, Al₂O₃ and SiO2). Owing to the large difference in specific gravities between the CRA and the slag, the CRA was deposited to the inner wall of the X60 backing pipe with the slag on top. Shortly after the completion of the reaction, the pipe was cooled by spraying water from both inside and outside and slag was removed using a separate mechanical operation. Examination of the cross sections of the cladded pipe showed a strong metallurgical bond has been formed between the cladded layer and the X60 steel backing.

### Example 7

An exothermic mixture containing iron oxide (Fe2O3), calcium (Ca), aluminium (Al) and silicon (Si), and alloying metals of chromium (Cr), nickel (Ni), iron (Fe), molybdenum (Mo), silicon (Si), and manganese (Mn) was loaded to the inside of the pipe by the BPS method while the pipe was in rotation at approximately 250 RPM (˜8 g). Afterward, a calculated amount of silica (SiO2) was loaded to the inside of the pipe by the BPS method while the pipe was in rotation. Then the pipe was rotated at 1150 RPM (˜185 g) and the mixture was ignited. Shortly after the completion of the reaction, the pipe was cooled by spraying water.

Upon the ignition and reaction, the mixture forms molten CRA of stainless steel 316L composition and a molten slag made of oxides (CaO, Al₂O₃ and SiO2). Owing to the large difference in specific gravities between the CRA and the slag, the CRA was deposited to the inner wall of the X60 backing pipe with the slag on top. Shortly after the completion of the reaction, the pipe was cooled by spraying water from both inside and outside and slag was removed using a separate mechanical operation. Examination of the cross sections of the cladded pipe showed a strong metallurgical bond has been formed between the cladded layer and the X60 steel backing.

### Example 8

A section of X60 carbon steel pipe having an outside diameter of 273.1 mm, a wall thickness of 11.1 mm and a length of 500 mm was not cleaned and used “as is” although it was exposed to the environment for a few years and contained visible rust. An exothermic mixture containing iron oxide (Fe₂O₃), nickel oxide (NiO), calcium (Ca), aluminium (Al) and silicon (Si), and alloying metals of chromium (Cr), iron (Fe), molybdenum (Mo), silicon (Si), and manganese (Mn) was loaded to the inside of the pipe by the BPS method while the pipe was in rotation at approximately 250 RPM (˜8 g). Afterward, the pipe was rotated at 1150 RPM (˜185 g) and the mixture was ignited. Shortly after the completion of the reaction, the pipe was cooled by spraying water.

Upon the ignition and reaction, the mixture forms molten CRA of stainless steel 316L composition and a molten slag made of oxides (CaO, Al₂O₃ and SiO₂). Owing to the large difference in specific gravities between the CRA and the slag, the CRA was deposited to the inner wall of the X60 backing pipe with the slag on top. Shortly after the completion of the reaction, the pipe was cooled by spraying water from both inside and outside and slag was removed using a separate mechanical operation. Examination of the cross sections of the cladded pipe showed a strong metallurgical bond has been formed between the cladded layer and the X60 steel backing.

The above examples for manufacture of stainless steel 316L cladded pipes can be extended to the manufacturing of other CRA clad pipes such as other stainless-steel compositions, nickel super alloys, and copper nickel alloys using appropriate transition metal oxides, thus manufacture of these CRA cladded pipes are also included in the scope of the current invention.

1. A composition of a mixture capable of an exothermic combustion synthesis reaction and suitable for a cladding process, comprising at least one transition metal oxide and at least one fuel composition,
wherein the fuel composition is at least a binary mixture selected from the group of aluminium, calcium, magnesium and silicon.

2. The composition according to claim 1, wherein the fuel composition is a binary, ternary or quaternary mixture selected from the group comprising aluminium, calcium, magnesium and silicon.

3. The composition of claim 1, wherein the fuel composition is a binary, ternary or quaternary fuel component comprising at least calcium and one component selected from the group comprising aluminium, magnesium and silicon, preferably from aluminium or silicon.

4. The composition of claim 3, wherein the fuel composition is a binary mixture of calcium and one component selected from the group comprising aluminium and silicon.

5. The composition according to claim 1, wherein the transition metal oxide is selected from the group comprising consisting of: copper oxides, iron oxides, nickel oxides, chromium oxides, cobalt oxides, niobium oxide, molybdenum oxides, and tungsten oxides, and mixtures thereof.

6. The composition according to claim 1, wherein the exothermic mixture further comprises other metals, metal alloys and/or their oxides, and/or fluorides.

7. The composition according to claim 1, wherein the exothermic mixture comprises at least one transition metal oxide and at least one fuel composition in a ratio appropriate to form the product phases with minimal excess fuel or oxide

8. The composition according to claim 1, wherein the exothermic mixture further comprises a metal selected from the group of copper, iron, tin, nickel, chromium, cobalt, vanadium, manganese, molybdenum, silicon, and alloys thereof.

9. The composition according to claim 1, wherein the exothermic mixture further comprises an alkaline earth metal oxide or fluoride, preferably an oxide or fluoride of barium, calcium, magnesium, and/or mixtures thereof.

10. The composition according to claim 1
wherein the exothermic mixture is designed to react to form a corrosion resistant alloy comprised of a stainless steel, copper-nickel alloy, nickel super alloy, or a cobalt super alloy.

11. The composition according to claim 1, wherein the exothermic mixture furthermore comprises one or more oxide component, preferably oxides of calcium, magnesium, silicon and/or boron oxide.

12. The composition according to claim 1, wherein the exothermic mixture is prepared from particulate materials having an average particle size in the range of from 20 μm up to 500 μm.

13. The composition according to claim 1 in the form of a pellet formed by uniaxial pressing of the exothermic mixture.

14. A process for producing corrosion resistant alloy clad metal pipes by:
(a) loading and distributing the exothermic mixture of the previous claims into one or more pipes in a clad assembly;
(b) igniting the exothermic mixture; and
(c) applying a post cladding pipe procedure.

15. The process according to claim 14, wherein loading and distributing the exothermic mixture into the one or more pipes in a cladding assembly is executed at a rotational speed suitable to generate a centrifugal force of at most 10 times the gravitational force and igniting the loaded exothermic mixture using an ignition system at a rotational speed generating a centrifugal force of at least 50 times the gravitational force.

16. The process according to claim 15, wherein loading and/or distributing the exothermic mixture to the steel pipes is done at a rotational speed generating a centrifugal force of at least 1 g, more preferably at least 2 g and at most 10 g, more preferably at most 8 g, and
wherein igniting the exothermic mixture is done using an ignition system at a rotational speed generating a centrifugal force of at least 100 g, preferably at least 150 g.

17. The process according to claim 14, wherein the corrosion resistant alloy comprises a stainless steel, copper-nickel alloy, or a nickel super alloy.

18. The process according to claim 14, wherein the cooling medium is water, preferably a water spray.

19. The process according to claim 14, wherein step (a) is being performed using blade powder spreading, RPM variation and/or paper tubing.

20. The process according to claim 14, wherein the clad assembly comprises an array of water spraying nozzles.

21. The process according to claim 14, wherein the post-cladding pipe procedure includes breaking off slag by mechanical means, more preferably by mechanical means assisted by the thermal shock water spraying and/or by surface machining.

22. The process according to claim 14, wherein before step (a) the metal pipes are prepared, preferably by cleaning thoroughly by media blasting and/or by using a chemical wash followed by drying.

23. The process according to claim 14, wherein green pellets prepared by uniaxial pressing of the exothermic mixture and resistance wire are placed inside the pipes, and connected to an electrical power supply unit.
